(19) United States
(12) Patent Application Publication
(10) Pub. No.: US 2010/0153280 A1
(43) Pub. Date: Jun. 17, 2010

(54) CONSTRUCTION PROJECT PREQUALIFICATION

(76) Inventors: Christina A. Fox, Grayslake, IL (US); Jeffrey K. Wagner, Wheaton, IL (US); Patrick J. Allin, Lake Bluff, IL (US); John W. Smith, Grayslake, IL (US)

Correspondence Address: MICHAEL BEST & FRIEDRICH LLP, 100 E WISCONSIN AVENUE, Suite 3300, MILWAUKEE, WI, 53202, US

(21) Appl. No.: 12/636,330

(22) Filed: Dec. 11, 2009

Related U.S. Application Data
(60) Provisional application No. 61/121,618, filed on Dec. 11, 2008.

(51) Int. Cl. G06Q 10/00; G06Q 30/00; G06Q 50/00; G06F 15/16

(52) U.S. Cl. 705/80; 709/227

(57) ABSTRACT

A networked computer system for acquiring prequalification information and comparing that prequalification information to a set of minimum requirements for a plurality of reviewing organizations. In some embodiments, the networked computer system also facilitates the project bidding process between prequalified organizations. The networked computer system receives bids from a prequalified bidding organization and assigns a rank to the bidding organization relative to other prequalified bidding organizations. In some embodiments, the networked computer system assigns a rank to the bid proposal based, in part, on the bidding organization's prequalification information and the information from the bid proposal.

### RELATED APPLICATIONS

This patent application claims priority to U.S. Provisional Patent Application No. 61/121,618 filed on Dec. 11, 2008, titled “CONSTRUCTION PROJECT PREQUALIFICATION,” the entire contents of which are herein incorporated by reference.

### BACKGROUND

The present invention relates generally to systems and methods for management of a construction project. In particular, the invention relates to systems and methods for effectuating prequalification between multiple organizations in the construction industry and for managing the project bidding process.

In a construction project, a project owner or general contractor solicits bids from other organizations (subcontractors, materials suppliers, etc). Participants in the construction project will be selected based on the information contained in the submitted bid proposal. However, some general contractors set minimum requirements relating to financial security and the ability of an organization to complete the project, and may require an organization to submit a prequalification application before allowing the organization to submit a bid for a project. Although various prequalification applications contain similar data, there is no standardized format. As such, the substance and format of the prequalification application is generally different for each general contractor. As such, an organization must undertake the tedious and time-consuming process of completing the prequalification application each time it wants to bid on a project with a new general contractor.

### SUMMARY

In one embodiment, the invention provides a systems and method of managing bid proposals from prequalified organizations. The computer-based system establishes electronic communication between a server and a first device through a computer network. The system then receives business information for a first organization from the first device through the computer network. The business information includes multiple data items relating to the first organization. The system also establishes electronic communication between the server and a second device through the computer network and receives minimum requirements from a second organization through the computer network. The minimum requirements include multiple data items defining requirements for candidates for prequalification. If the business information meets the minimum requirements, the first organization is able to submit bid proposals to the second organization. If not, the system does not allow the first organization to submit business proposals.

Other aspects of the invention will become apparent by consideration of the detailed description and accompanying drawings.

### BRIEF DESCRIPTION OF THE DRAWINGS

FIG. 1 is a schematic diagram of a networked construction project prequalification system according to one embodiment.

FIG. 2 is a block diagram of the construction project prequalification system according to one embodiment.

FIG. 3 is a flowchart showing another embodiment of the prequalification process.

FIG. 4 illustrates a user interface showing an overview of data items in a library.

FIG. 5 illustrates a user interface showing a prequalification request notification.

FIG. 6 is a relational diagram illustrating different types of subscription services available according to one embodiment of the prequalification system.

FIG. 7 illustrates a user interface showing a request for additional information notification.

FIG. 8 is an example of a first aggregated data document according to the process of FIG. 3.

FIG. 9 is an example of the final aggregated approval document according to the process of FIG. 3.

FIG. 10 is an example of data flow between participants according to the process of FIG. 3.

FIG. 11 illustrates a user interface showing a request prequalification form.

FIG. 12 is a flowchart of one embodiment of the prequalification process.

FIG. 13 illustrates a user interface showing a notification requesting manual prequalification review.

FIG. 14 is a flowchart showing the project bidding process for a prequalified subcontractor.

FIG. 15 illustrates a user interface showing a list of available projects.

FIG. 16 illustrates a user interface showing a list of currently pending bids.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

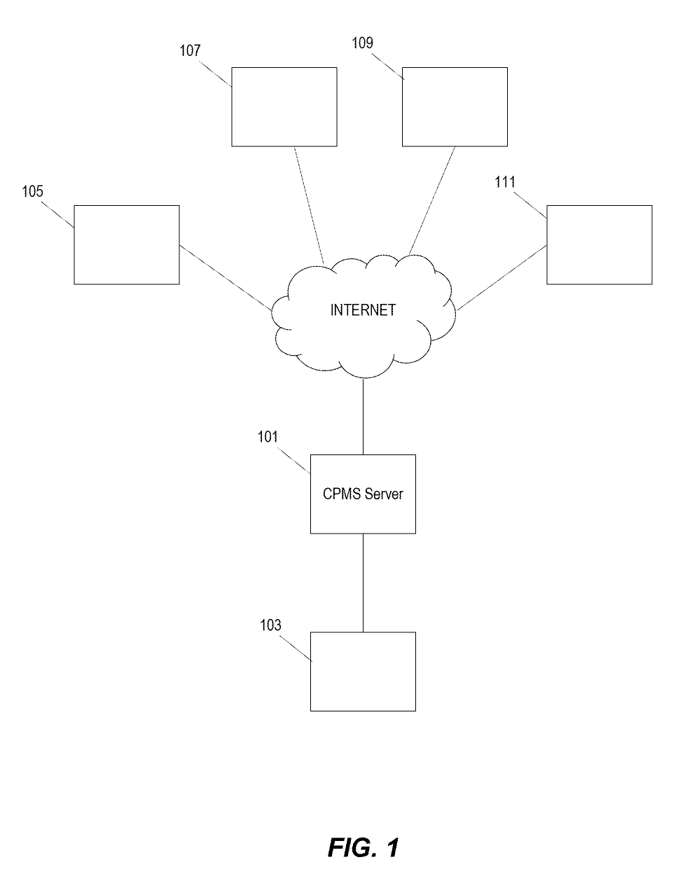

FIG. 1 schematically illustrates a network-based construction project management system (CPMS) that includes a prequalification system. A CPMS server 101 stores data related to one or more construction projects, processes payment and scheduling information, and provides a communication interface for participants associated with a construction project. One such CPMS is described in U.S. patent application Ser. No. 11/032,699, the entire contents of which are incorporated herein by reference. Although the prequalification system is described below as being integrated into a CPMS, the prequalification system can alternatively be implemented as a standalone system.

The CPMS server 101 includes one or more memory devices (e.g., hard disk drive or flash memory), one or more processors, and network connectivity. The memory device of the CPMS server 101 stores computer executable instructions that provide a graphical user interface and execute methods such as described in detail below. The computer executable instructions can be provided in any appropriate computer language including, for example, C, C++, or Java. The graphical user interface can similarly be encoded using any appropriate computer language, such as HTML. The CPMS server 101 provides a web-based user interface that is accessible through a variety of remote computer systems 103, 105, 107, 109, and 111. The remote computer systems connect directly to the CPMS server 101 through a local area network or connect to the CPMS server 101 through an Internet connection. The remote computer systems of FIG. 1 can be any web-enabled electronic device including, for example, a personal computer, personal digital assistant (PDA), or cellular telephone.

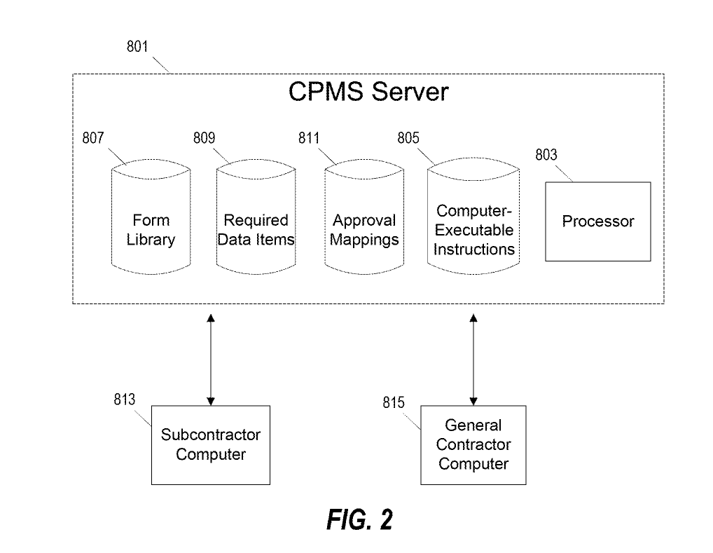

FIG. 2 illustrates one example of a CPMS server 801 that includes a processor 803 for executing instructions stored on a first computer readable memory 805. The CPMS 801 also includes a memory storing a form library 807. The form library includes data items provided by an organization for possible inclusion in a prequalification application as described in further detail below. Once data items are provided to the form library by an organization, the organization can complete multiple prequalification applications by reusing the data items provided to the form library to complete the prequalification applications as described in more detail below. The ability to reuse the same data items for multiple applications increases efficiency by not requiring the user to reenter the same data every time a new prequalification application is completed.

The contents of the form library include files stored in various different formats. The stored files can include forms generated by the CPMS 801 based on information provided by an organization, documents created by other systems and uploaded to the CPMS 801 (e.g., pdf documents), individual textual data items entered by a user into the graphical user interface of the CPMS 801, or various other file formats. As described in further detail below, the data items stored in the form library include information relating to the operation of an organization seeking prequalification. The data items can include, for example, general business information, business classification, operating capabilities, contracting information, a list of employees, general diversity information, geographical areas of operation, LEED accreditation, union agreements, licenses, performance information, product service segments, bank information, financial information, financial statements, references, litigation information, quality assurance procedures, safety information, bonding compliance requirements, automobile insurance information, pollution insurance information, employers liability insurance information, general liability insurance information, professional liability insurance, umbrella insurance information, worker's compensation insurance information, any additional insurance information, and lien history information.

The CPMS server 801 also includes a memory 809 storing at least one request package for each reviewing organization (e.g., a general contractor) that is registered with the system. As described in detail below, a request package defines the data items that are required to complete a prequalification application. The request package is a reusable construct that can be provided by the prequalification system as a uniform request for data items each time a new submitting organization is being considered for prequalification with a specific reviewing organization. As further illustrated below, although the reviewing organization's prequalification application will include a unique set of data items arranged in a unique format, the reusable request package allows the reviewing organization to request the unique set of data items in a format that is readily available to all submitting organizations using the prequalification system. Like the data items in the form library, a reviewing organization is able to reuse the same package to request data items from multiple submitting organizations (e.g., a subcontractor). Again, the ability to reuse this data increases efficiency by allowing the reviewing organization to request a list of data items in a generalized format without requiring the reviewing organization to redefine the list of data items each time a new prequalification application is generated. Additionally, a reviewing organization can create multiple unique request packages tailored for respective projects, kinds of projects, geographical locations, etc.

The memory 809 can also include various prequalification application templates that can be populated with the data items from the form library 807 as described below. As described in detail below, some embodiments require different participants within an organization to review and approve individual data items in a prequalification application. As such, the CPMS 801 also includes a memory 811 that stores mappings that identify which participant provides approval for which data items in the prequalification application. Although the memories 805, 807, 809, and 811 are illustrated as separate memory units in FIG. 2, the memories can also be embodied as different memory locations on the same memory unit (e.g., hard drive disk).

The CPMS 801 can be accessed through a network by various other computers 813, 815 so that participant organizations such as a subcontractor (computer 813) and a general contractor (computer 815) can access and modify data stored in the various memories and can execute computer programs stored on the memory 805.

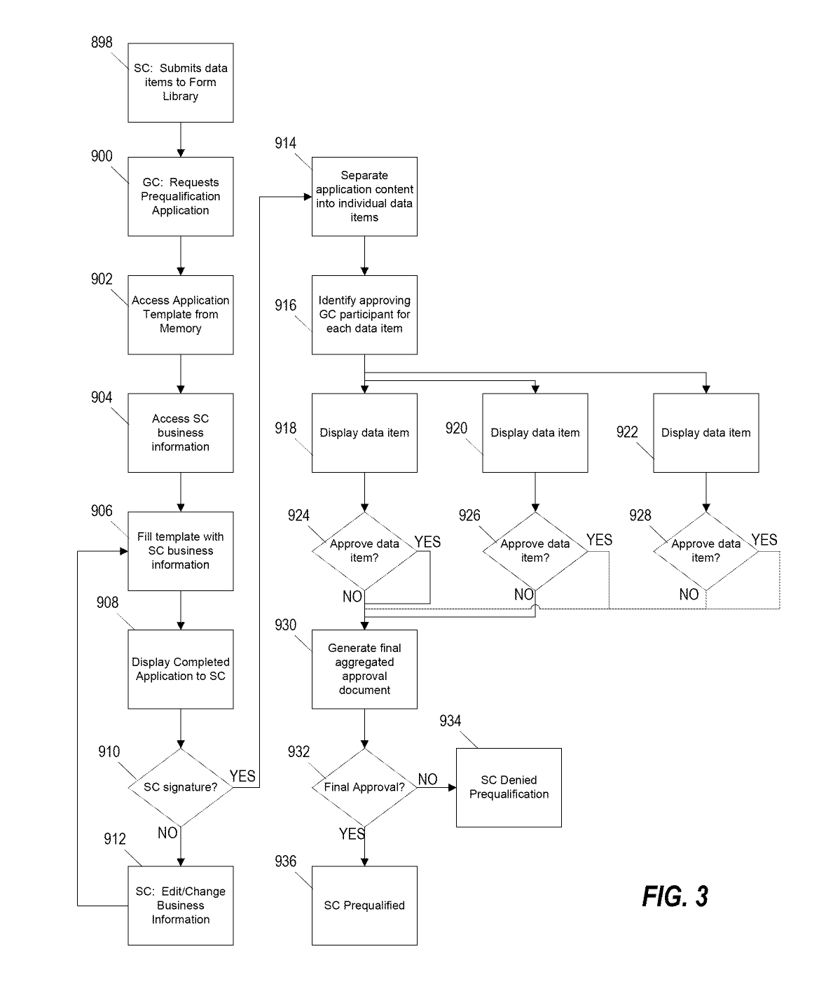

FIG. 3 illustrates an example of one method using the CPMS 101 of FIG. 2. In the example of FIG. 3, a subcontractor organization is registering with the CPMS and completing the prequalification process for a general contractor. As such, the subcontractor is acting as the submitting organization and the general contractor is the reviewing organization. However, the prequalification system follows a similar process for other prequalification requests including, for example, those between project owners and general contractors, subcontractors and materials suppliers, and project owners and architects.

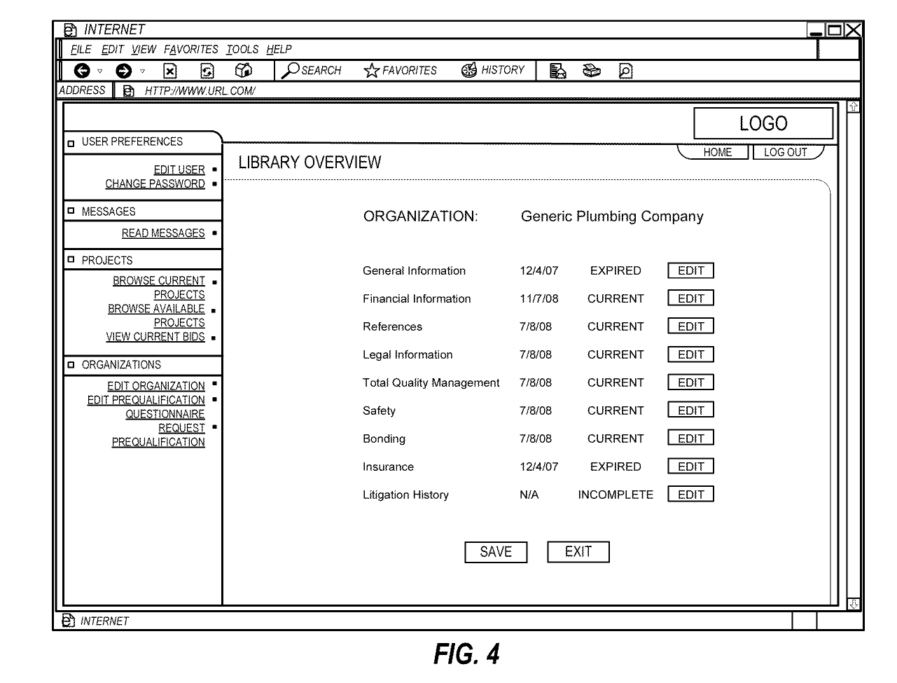

A submitting organization (e.g., the subcontractor) begins by submitting data items for inclusion in the form library (step 898). As described above, the data items can be provided by uploading electronic documents created outside of the system, by completing editable “prequalification questionnaires” provided by the system, or by other various methods of data entry. FIG. 4 shows an example of an overview page for the contents of a subcontractor's data library. The prequalification system according to this embodiment is designed to acquire a wide array of information related to the business operations of a construction project entity. Data that may be provided by the subcontractor to the data library includes general business information, financial information, references, legal information, total quality management information, safety information, bonding information, insurance information, and litigation history.

General business information can include contact address, personnel, minority status, federal status, licensing information, experience, and trade designation. Financial information gathers relevant banking information as well as financial statements and federal and state tax filings. Because the prequalification system and the CPMS are used by multiple construction-related entities for multiple construction projects, the references can be provided as either a link to another participant registered with the CPMS or can include the name and contact information for an industry entity that does not use the CPMS or prequalification system.

The subcontractor's data library can also store information related to the organization's total quality management (TQM) programs and safety programs (including a list of OSHA violations). Information related to bonding (e.g., agents and capacity), insurance (liability, workers' compensation, auto, etc.), and prior or pending litigation including, for example, bankruptcy and contract disputes, are also collected.

Some of the data provided to the library can include an associated expiration date. The inclusion of an expiration date ensures that the data used to complete the prequalification process is current. The expiration date can be set by the submitting party (e.g., the subcontractor), the reviewing party (e.g., the general contractor), or the system. As shown in FIG. 4, the overview page of the subcontractor's data library displays the date on which the data was last updated and whether the data is current or expired. The user can add, edit, or update data by selecting the appropriate “Edit” button.

Returning to FIG. 3, the prequalification process can be initiated by the submitting organization or the reviewing organization (e.g., the subcontractor or the general contractor, respectively). Regardless of which organization initiates the process, the system requests a prequalification application on behalf of the general contractor (i.e., the reviewing organization) (step 900). This request includes a request package that lists all of the data items that the reviewing organization requires for consideration for prequalification.

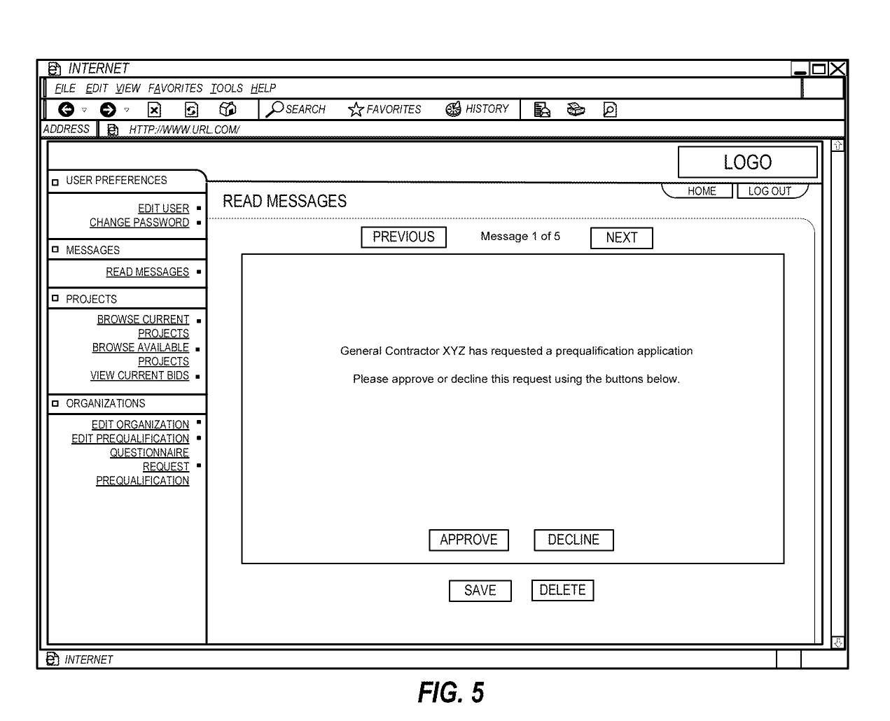

None of the information or organization data stored to the system is transferred between entities using this embodiment of the prequalification system without express permission from the owner of the data (e.g., the submitting organization). FIG. 5 illustrates a notification that is sent to a subcontractor when a general contractor has requested data for prequalification review (step 900, FIG. 3). The prequalification system sends the notification to the subcontractor's inbox. The notification provides the identity of the general contractor requesting the information (“General Contractor XYZ”) and provides two buttons allowing the user to select whether to allow the general contractor to access and process the data items from the library.

The system accesses a prequalification application template from memory (step 902) and accesses business information provided by the subcontractor from the form library (step 904). The system then fills the template application with the subcontractor's business information (step 906). Although each reviewing organization typically has a slightly different prequalification application, much of the business information required to complete the application is the same. As such, the system is able to generate a completed prequalification application for submission to the reviewing organization based on previously stored business information relating to the subcontractor. However, reviewing organizations are able to define a customized set of information that is required for consideration for prequalification. Similarly, submitting organizations can choose which information to include in the form library. As described above, the data items in the form library can be reused for multiple prequalification applications. As such, the submitting organization is not required to enter a completely new set of data items for each new prequalification application.

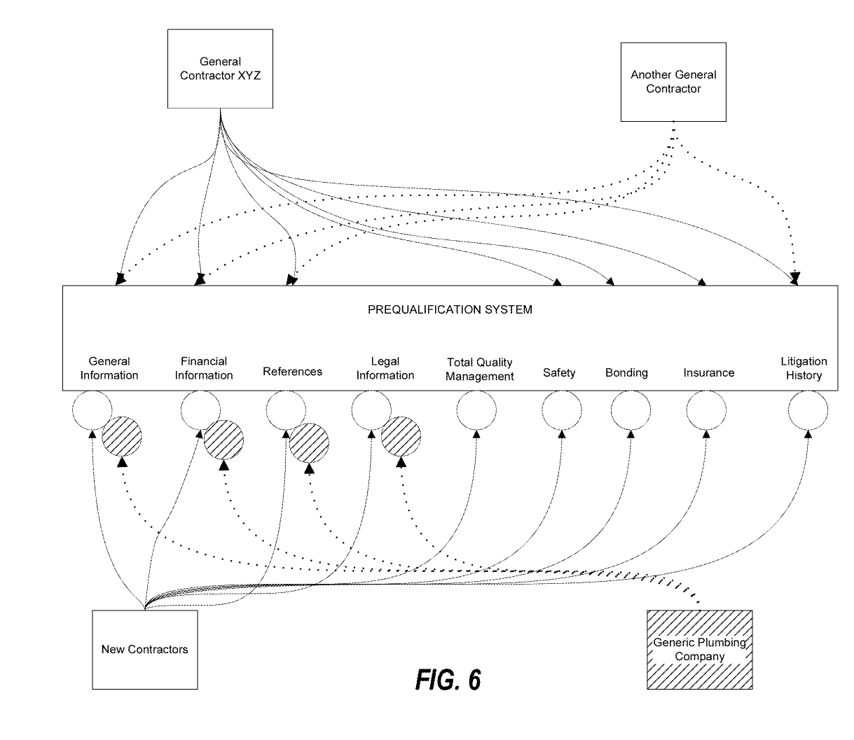

FIG. 6 illustrates the overlap and differences in information requested by some reviewing organizations and provided by some submitting organizations. In this example, “General Contractor XYZ” requires general, financial, references, safety, bonding, insurance, and litigation history information when conducting a prequalification review. Therefore, request packages sent by General Contractor XYZ do not include information related to TQM or legal status and, as such, General Contractor XYZ does not receive that information from the subcontractor during the prequalification review. In contrast, “Another General Contractor” requires less information and only receives general information, financial information, references, and litigation history when a prequalification request is received.

Similarly, as described above, submitters can choose to submit only a subset of information when registering and populating the data library. As shown in FIG. 6, although “New Contractors” has submitted information for all of the categories in the data library, “Generic Plumbing Company” has only submitted data related to general information, financial information, references, and legal information. As such, “New Contractors” is able to submit a complete prequalification application to both “General Contractor XYZ” and “Another General Contractor” without providing additional information.

In contrast, the data items included in the form library for “Generic Plumbing Company” will be insufficient to prepare a completed prequalification application for either “General Contractor XYZ” or “Another General Contractor.” As such, when attempting to complete a prequalification application for “Generic Plumbing Company,” the system will identify that some required information is missing and display a notification to the “Generic Plumbing Company.”

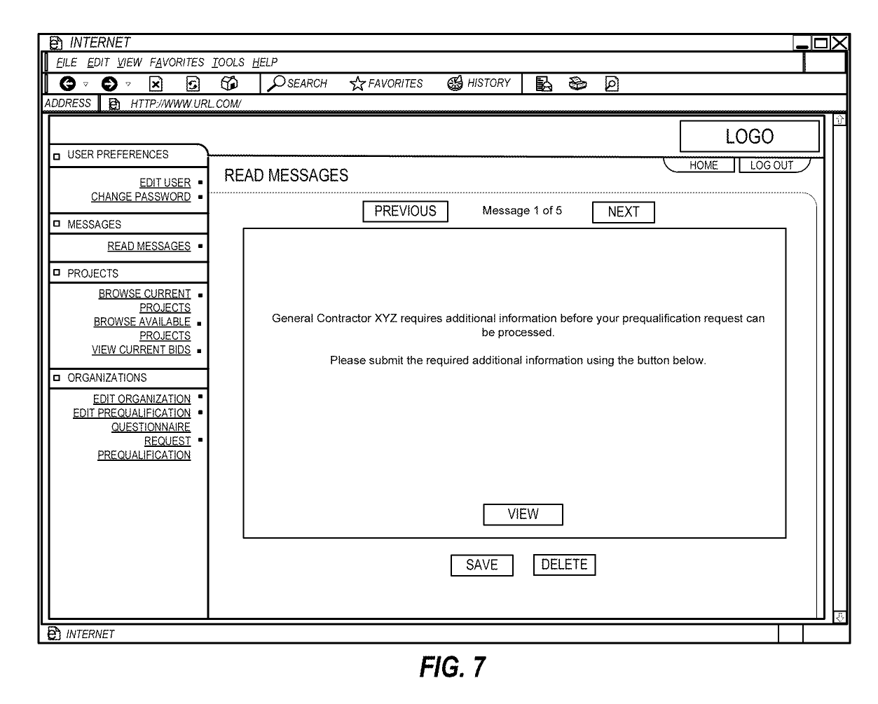

FIG. 7 illustrates an example of a notification that is provided to a submitting organization when the data items included in the form library are insufficient to complete a prequalification application. This notification can be sent in the form of an email (or other electronic communication) or can be displayed to the user as an on-screen notification when the user is attempting to submit an incomplete application package. The notification in this example prompts the subcontractor to click the “view” button, which then presents a screen identifying the information required before the prequalification request is processed.

Alternatively, in some embodiments, the subcontractor is given the option of submitting a prequalification application that is missing information that is generally required by the general contractor. Upon receiving an incomplete prequalification application, the general contractor can decide to review the application as is or to refuse to consider the prequalification application until after the missing information is provided. In some embodiments, the notification of FIG. 7 provides the subcontractor the option of providing the missing information, canceling the submission process, or submitting the prequalification application without the missing information.

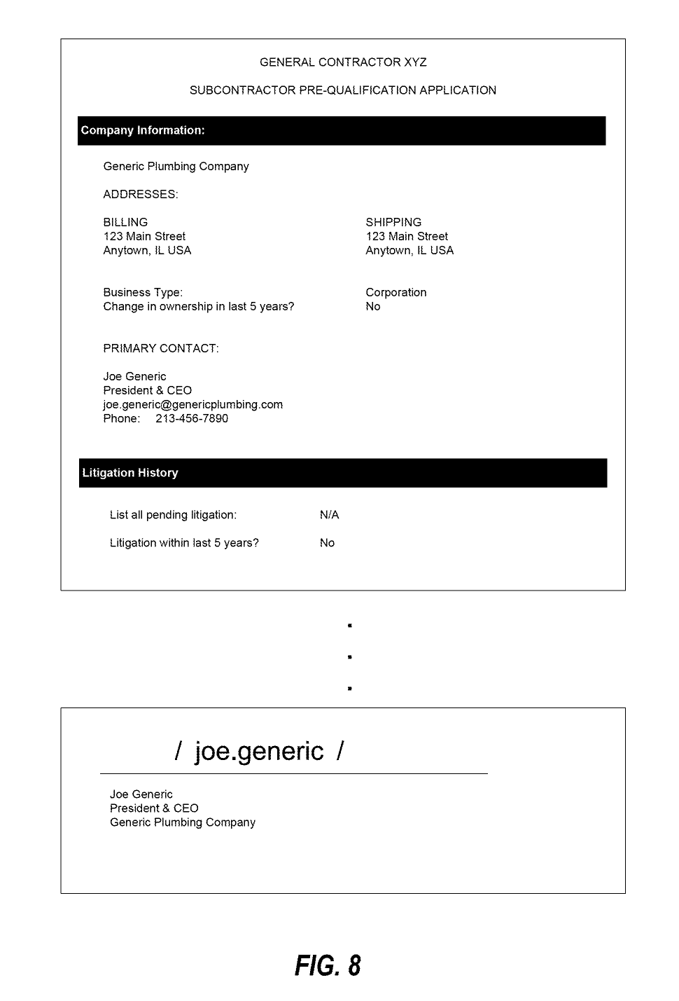

Returning again to FIG. 3, after the prequalification application has been completed by the system it is displayed to the subcontractor for review (step 908). If all of the information is correct and the completed application is satisfactory, the subcontractor confirms the accuracy of the provided data items by providing a signature (step 910). In some cases, the system allows the user to provide an electronic signature for the document before forwarding the application to the reviewing organization. In other situations, the subcontractor may be required to print the prequalification application and provide a physical signature. This completed application is one example of a first aggregated data document. FIG. 8 provides an example of one completed prequalification application. The application is in page format and lists information about the subcontractor. A representative of the subcontractor organization provides either an electronic or physical signature on the bottom of the page.

Some embodiments also include an auto-submit module that can be turned on or off at the discretion of the submitting organization. After receiving a request package from a reviewing organization, the auto-submit module automatically provides the requested data items to the reviewing organization without requiring a signature or approval from the submitting organization. When the auto-submit module is turned on, the submitting organization never sees the completed prequalification application. The submitting organization (e.g., the subcontractor) is notified of the data items requested by the general contractor and simply confirms that data items are stored on the system and are accurate.

Returning to FIG. 3, if the subcontractor determines that some of the information provided in the prequalification application is inaccurate, incomplete, or otherwise unsatisfactory, the subcontractor is able to edit, change, or update the information (step 912). In some embodiments, the subcontractor is able to edit the information directly in the prequalification application using an editable text field. However, in some cases, the subcontractor will be required to change the data item as stored on the server. After the necessary changes are made to the subject data item(s), the system again fills the application template (step 906) and displays the application to the subcontractor for a signature (steps 908 & 910).

After the prequalification application (or other first aggregated data document) is signed by the subcontractor, the system requests approval of the prequalification application from the general contractor. In some situations, the entire prequalification application is provided to a single approving participant associated with the general contractor organization. However, in some embodiments, the system breaks down the data items included in the application into individual data items (step 914) and requests approval of each individual data item separately. In some cases, different data items must be approved by different participants in the general contractor organization.

The system stores a mapping file that identifies the participants associated with the general contractor organization and lists the data items from the prequalification application that must be approved by each participant (step 916). In this example, there are three data items in the prequalification application that must be approved by three different participants associated with the general contractor. Each of the three data items are displayed to each of the three identified participants the next time they access the system (steps 918, 920, & 922). The participants then either approve or reject the respective data item (steps 924, 924, & 928). At this stage, the participants can also provide a rating of the data item on a scale of one to five. The rating scale can be different in other embodiments such as a one to ten scale or a percentage-based scale.

In this example, the general contractor and the approving participants associated with the general contractor are provided with copies of data that originated from the subcontractor's library. The general contractor does not have direct access to the subcontractor's library. As such, a data item can be modified for the specific prequalification application without changing the data item as stored in the library. Similarly, if a data item is changed in the library after the prequalification application has been submitted, the general contractor may not automatically receive the updated data items.

As discussed above, the reviewing organization (the general contractor in this example) is able to define which participants are required to approve individual data items and the prequalification application as a whole (i.e., the mapping file). Furthermore, the general contractor can define which “non-approving” participants are able to view information submitted with the prequalification information. For example, a first participant within the general contractor organization may be required to approve only the insurance information submitted by the subcontractor. However, the first participant may be able to view the prequalification application as a whole. Similarly, a second participant may not be required to approve the insurance information, but may be provided access to view the insurance information.

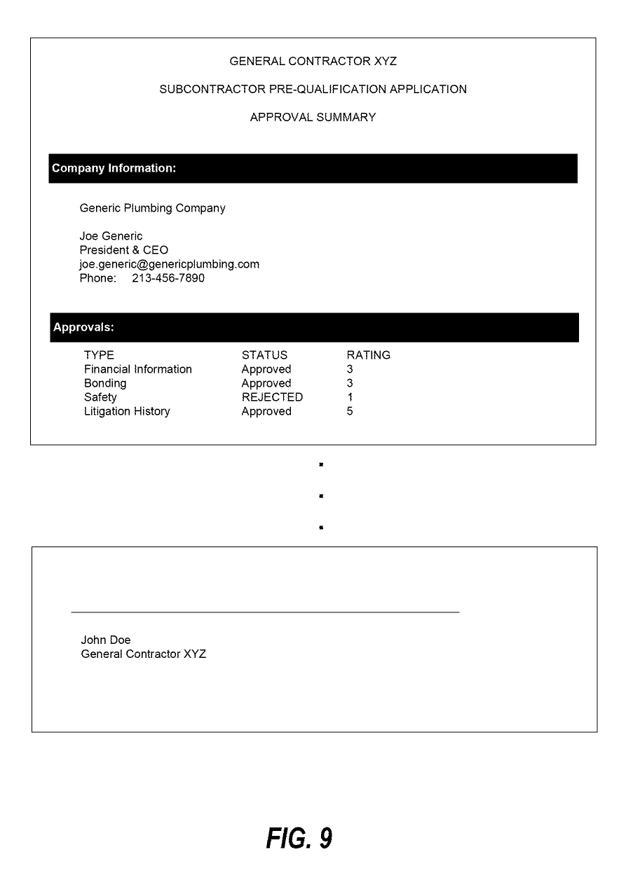

After the individual data items have been considered by one or more participants within the reviewing organization, they are recompiled into a final aggregated approval document with ratings and approvals assigned by the individual participants associated with the reviewing organization (step 930). The final aggregated approval document can be displayed in a variety of ways. For example, it can be shown electronically by displaying a list of data items and the corresponding approvals and ratings in a graphical user interface. Alternatively, the final aggregated approval document can be compiled as a printable, page-format summary document that can be viewed and printed by the general contractor. FIG. 9 provides an example of the latter. The aggregated approval document provides some information related to the subcontractor organization and also lists the results of the individual data item approvals. In the example of FIG. 9, the finance information, bonding information, and litigation history information has been approved. However, the safety information provided by the subcontractor has been rejected. This rejection could be because the details of the information are either not provided or are determined to be insufficient.

In some embodiments or depending upon preference settings for the general contractor, the system can be configured to automatically reject the prequalification application as a whole if any of the individual data items have been rejected. Alternatively, the reviewing organization can approve a prequalification application despite a rejection of one or more individual data items. Furthermore, in some embodiments, the reviewing organization is able to send a notification to the submitting organization providing further details regarding a rejected data item and request that the submitting organization modify the business practices associated with the data item. For example, if the subcontractor's insurance is insufficient, the system can send a notification to the subcontractor stating that the prequalification application will be rejected in its current form, but might be approved if insurance coverage is increased.

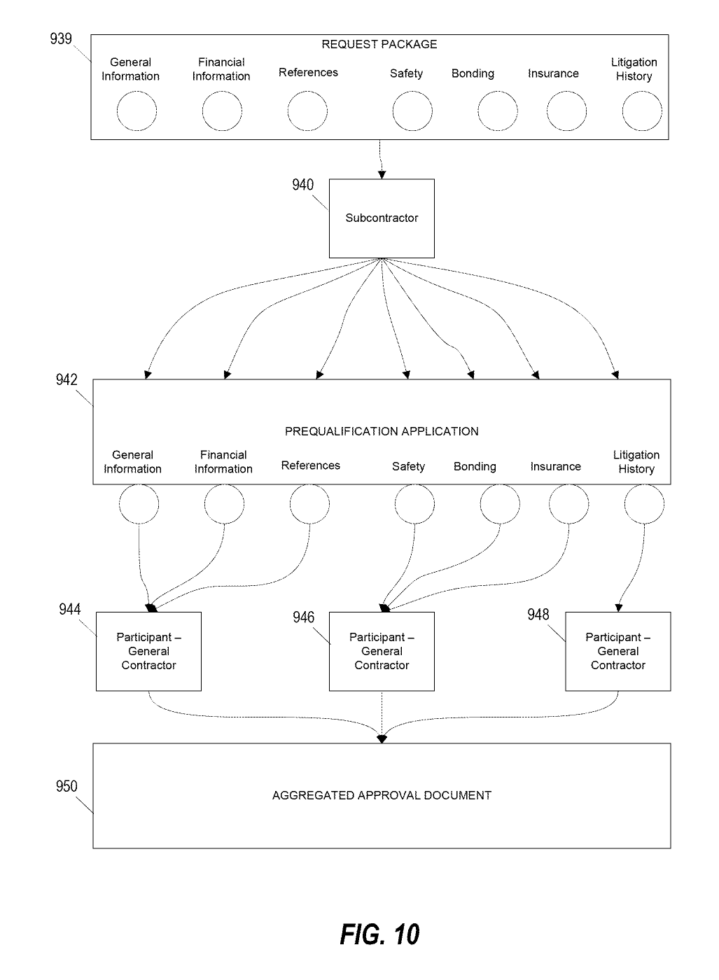

FIG. 10 further illustrates the aggregation and disaggregation of the data items that occurs in steps 900, 906, 914, and 930. As described above, the general contractor sends a request package 939 to the subcontractor that includes a list of all of the data items that are required for the completion of the prequalification application. The subcontractor 940 provides data items to the system which are then compiled into a completed prequalification application 942 for signing by the subcontractor (step 906 in FIG. 3). The data items from the prequalification application 942 are then separated (step 914 in FIG. 3) and forwarded to different participants associated with the general contractor for approval. In the example of FIG. 10, general information, financial information, and a list of references provided by the subcontractor are forwarded to a first participant 944 for approval. Safety, bonding, and insurance information are forwarded to a second participant 946 and litigation history is reviewed by a third participant 948. Approvals or rejections are received by the first, second, and third participants, 944, 946, and 948, respectively, and are incorporated into the final aggregated approval document 950 (step 930 in FIG. 3).

As mentioned above, in some situations, the subcontractor can choose to submit the prequalification application without providing all of the requested materials. In some embodiments, depending upon preference settings configured by the general contractor, data items that are missing can be displayed on the aggregated approval document in a different color, font, typeface (e.g., bold), or other visual indication. Alternatively, prequalification applications with missing data items can be filtered out entirely.

After reviewing the aggregated approval document, the general contractor organization provides a final approval or rejection of the subcontractor applicant (step 932). If the application is rejected, a notification is sent to the subcontractor and the subcontractor is not permitted to bid on the general contractor's construction projects (step 934). However, if final approval is granted, the subcontractor is approved to bid on construction projects posted by the general contractor and an indication of this approval is stored on the system (step 936). Depending upon the embodiment of the system or the preferences of the general contractor, final approval of the prequalification application can be provided by an electronic signature, a physical signature on the aggregated approval document, or by simply clicking an “approve” button on the system's graphical user interface.

Some embodiments of the invention provide additional information that can be accessed and reviewed by the general contractor during the prequalification process. For example, as described above, the prequalification functionality can be integrated into or connected to a construction project management system (CPMS). The CPMS can include functionality that allows a general contractor to evaluate the performance of the subcontractor during a project. In some embodiments, previously submitted evaluations are compiled and an evaluation score is generated for the subcontractor by the prequalification system.

The prequalification functionality can also be integrated into or interface with a bid management system. Such systems may keep track of the total number of projects for which the subcontractor has submitted bids, the total number of projects awarded to the subcontractor based on those bids, and the dollar value (e.g., budget) of the awarded projects. In some embodiments, the prequalification system can make this information available to a reviewing organization (e.g., the general contractor) during the prequalification process.

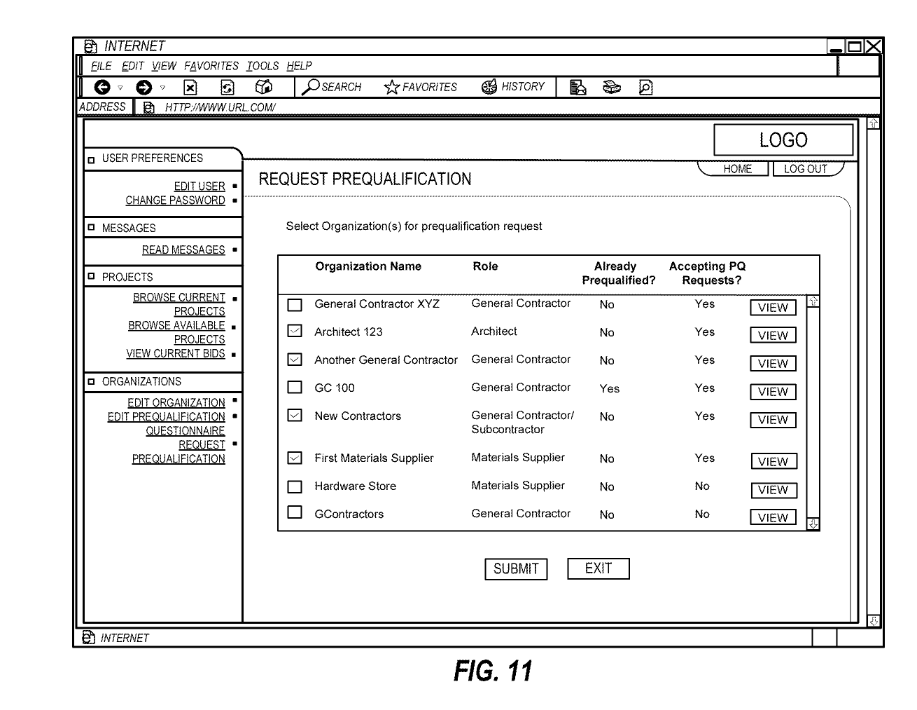

As described above, the prequalification process can be initiated by either the reviewing organization (e.g., a general contractor) or by a submitting organization (e.g., a subcontractor or material supplier). FIG. 11 illustrates an example of a screen interface provided by the prequalification system prompting a submitting organization to request prequalification from one or more organizations. The interface provides a list of organizations registered with the prequalification system and identifies the role associated with the organization (e.g., general contractor, subcontractor, architect, etc.). The list also indicates whether the organization is accepting prequalification requests and if the user is already prequalified with the organization. The user presses the “View” button located next to each organization listing to view additional information about the organization including, for example, a list of currently pending projects and currently open bids. The user then selects one or more organizations using the check boxes to the left of the listing and clicks the “Submit” button at the bottom of the interface to initiate the prequalification process for the selected organizations.

The same or similar interface that is used by the submitter when requesting prequalification from a reviewer can be used by the user when acting in a “reviewer” capacity. For example, “Generic Plumbing Company” can use the interface of FIG. 11 to request prequalification from “Another General Contractor.” “Generic Plumbing Company” can then use the same interface to request prequalification information from “First Material Supplier.” “Generic Plumbing Company” is acting as submitter in the first example, and acting as reviewer in the second.

Because reviewing organizations are able to browse a listing of potential submitting organizations, the interface of FIG. 11 can be utilized by subcontractors, material suppliers, and other potential submitting organizations as a marketing tool. The potential submitting organization can choose to make certain information available for browsing. This information can include, for example, a summary of the organization's operational capacity, abilities, performance history, and even reviews or testimonials provided by previous customers. As such, a general contractor looking for a new subcontractor to invite for prequalification can use the prequalification system to browse through subcontractors that are already registered with the system.

As shown in FIG. 11, not all organizations accept prequalification requests. This may be because the organization is not interested in working with any additional organizations at this time. However, it may also be because the organization prefers to initiate the prequalification request itself. For example, “Hardware Store,” a material supplier, has indicated that it does not want reviewers requesting prequalification information. Instead, “Hardware Store” itself will initiate the prequalification process. Similarly, “GContractors,” a general contractor, has indicated that it does not want to receive unsolicited requests for prequalification. These preferences are defined by the organization when it registers with the CPMS or the prequalification system.

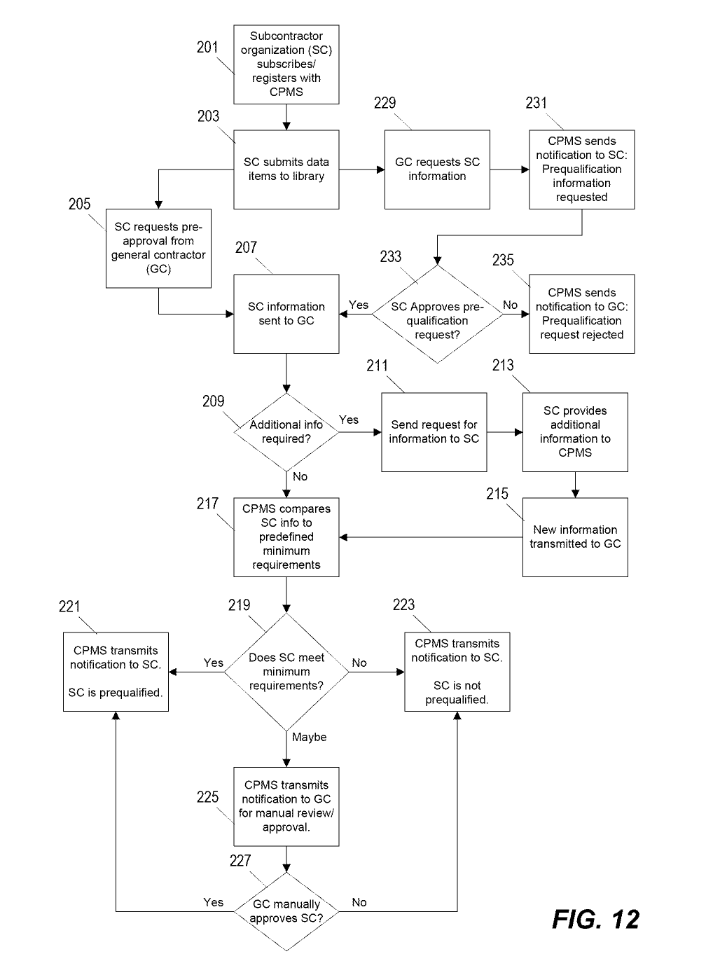

The examples provided above describe a system for automatically generating a prequalification application and for requesting and receiving manual approvals of the content of the prequalification application. However, in some embodiments, the system provides for automatic approval or rejection of prequalification applications. FIG. 12 illustrates one such automated prequalification process using the CPMS server of FIG. 2. The subcontractor organization begins by registering with the CPMS (step 201). Before using the prequalification system, the subcontractor organization (the “submitting organization”) provides various data items to populate a library of data items that are stored on the prequalification system (step 203). As described above, the data items can be uploaded as individual documents (e.g., electronic documents regarding the subcontractors business operation submitted in PDF format) or can be submitted through one or more prequalification questionnaires provided by the prequalification system (e.g., editable forms with text fields).

After providing data items to the library, the subcontractor browses through a list of general contractors and other construction project participants that may be accepting applications for prequalification (see, FIG. 11 above). The subcontractor organization identifies a general contractor (the “reviewing organization”) and requests prequalification approval (step 205). Data from the subcontractor's library is then sent to the selected general contractor (step 207).

As discussed above, a reviewing organization may require data items that have not yet been provided to the submitting organization's form library. If the selected contractor requires additional information that has not already been provided by the subcontractor in the library (step 209), the prequalification system sends a notification to the subcontractor identifying the required additional information (step 211). The subcontractor provides the required additional information (step 213), which is transmitted to the CPMS and to the selected general contractor (step 215). The CPMS then compares the information submitted by the subcontractor with predetermined criteria defined by the general contractor (step 217). The predetermined criteria include a list of minimum requirements for prequalification and an indication of preferences and weightings that are used to rank prequalified subcontractors during the bidding process.

If the subcontractor meets the minimum requirements for prequalification (step 219), a notification is sent to the subcontractor (step 221) and the subcontractor is allowed to bid on projects with the selected general contractor. However, if the subcontractor does not meet the minimum requirements for prequalification, the system sends a notification (step 223) and the subcontractor is prevented from submitting bids on projects associated with the selected general contractor.

In some cases, the automated prequalification system may not be able to determine whether a particular subcontractor meets the minimum requirements. In such cases, the system sends a notification to the general contractor and requests manual review and approval of the subcontractor (step 225). For example, a general contractor can set a minimum threshold value for automatic approval and a maximum threshold for automatic rejection. When the value of a data item falls in the intermediate range between the approval minimum and the rejection maximum, the system requires a manual approval or rejection from the general contractor. After the general contractor approves or declines the prequalification request (step 227), the applicable notification is sent to the subcontractor (step 221 or 223).

The prequalification process can also be initiated by the general contractor. In such cases, the general contractor requests access to the data items from the subcontractor's library (step 229). A notification is sent to the subcontractor (step 231) requesting approval of the data access. In this embodiment, no data is shared with any participant registered with the CPMS without the express approval of the owner of the data. If the subcontractor approves the request for information (step 233), copies of data items from the subcontractor's library is sent to the general contractor and the automated prequalification system (step 207) and the prequalification process continues as described above. However, if the subcontractor declines the request for information (step 233), the system sends a notification to the general contractor (step 235) and the prequalification process does not continue.

The prequalification system according to this embodiment includes an automated filtering system that compares information submitted the submitting organization's library to minimum requirements defined by the reviewer. To effectuate this automated filtering system, the reviewer completes a form that defines the minimum requirements. Numeric fields such as, for example, minimum insurance coverage, minimum number of employees, and value of inventory, can be evaluated through a one-to-one comparison or evaluated on a weighted scale. For example, a submitting organization may be prequalified even if one category does not meet the minimum requirements of the reviewing organization provided that another related category exceeds the required minimum by a certain amount.

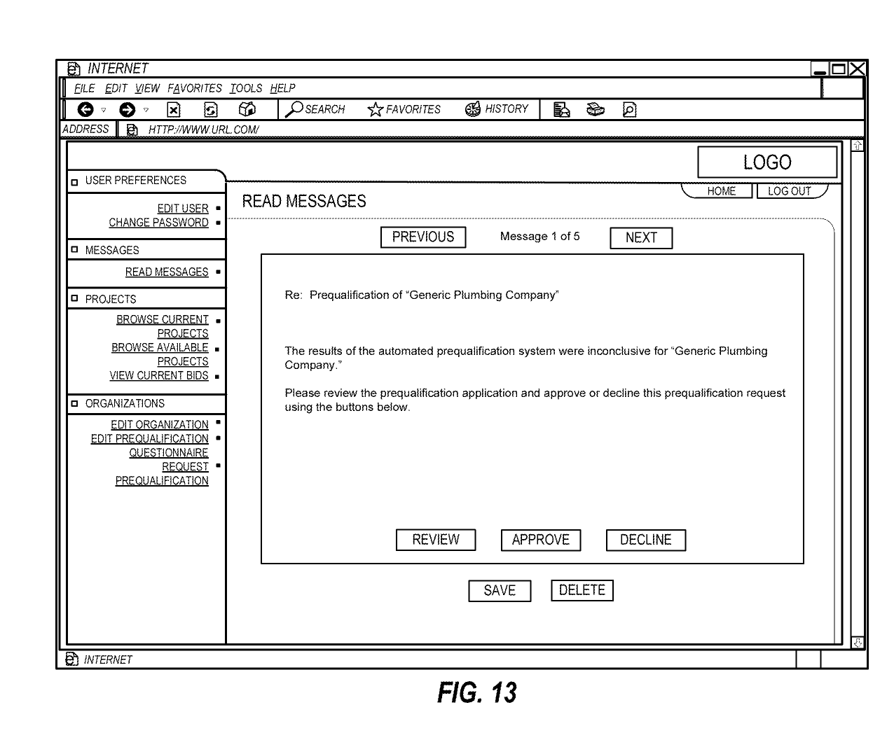

However, in some cases, the automated filtering system may not be able to make an adequate determination. For example, if several of the categories are near or below the threshold, the final prequalification determination may be based on comments from the submitting organization's references or other textual information provided in the submitting organization's library. In such cases, the prequalification system will send a notification to the reviewing organization requesting a manual review of the prequalification application (step 225, FIG. 12). FIG. 13 provides an example of such a notification. The reviewing organization can view some or all of the data from the submitting organization's prequalification application by clicking the “Review” button. The reviewing organization then either approves or declines the prequalification request by selecting the applicable button.

Although the example described above discusses an automated prequalification system that automatically approves or rejects a prequalification application, other systems are able to provide an automatic rejection of a prequalification application, but require manual approval of the application. In such systems, the general contractor defines the one or more minimum requirements. If the value of a data item submitted in the prequalification application does not meet the minimum requirement, the application is automatically rejected without requiring any intervention from the reviewing organization. However, if the value of the data item exceeds the minimum requirement, the prequalification is forwarded to the reviewing organization for manual review.

In still other embodiments, the prequalification system does not automatically reject the application when the value of the data item falls below the minimum requirement. Instead, the system flags the data item as insufficient when the reviewing organization begins its manual review. The insufficient data item can be flagged using a different text color, using a different typeface, by providing an on-screen notification, or by other methods of alerting the reviewing organization.

Although the systems described above facilitate the approval of prequalification applications by routing data items for approval or by automatically approving the data items, the system can also be used to complete prequalification applications for reviewing organizations that are not registered with the system. In such situations, the submitting organization can upload a copy of the off-system reviewing organization's prequalification application to the system. The system will fill in the necessary fields and compile other necessary documentation from the submitting organization's library. The completed application can then be printed by the submitting organization and manually submitted to the off-system reviewing organization. Alternatively, the system can provide a standard, uniform format for a prequalification application that can be generated using data items from the library and printed for manual submission to an off-system reviewing organization.

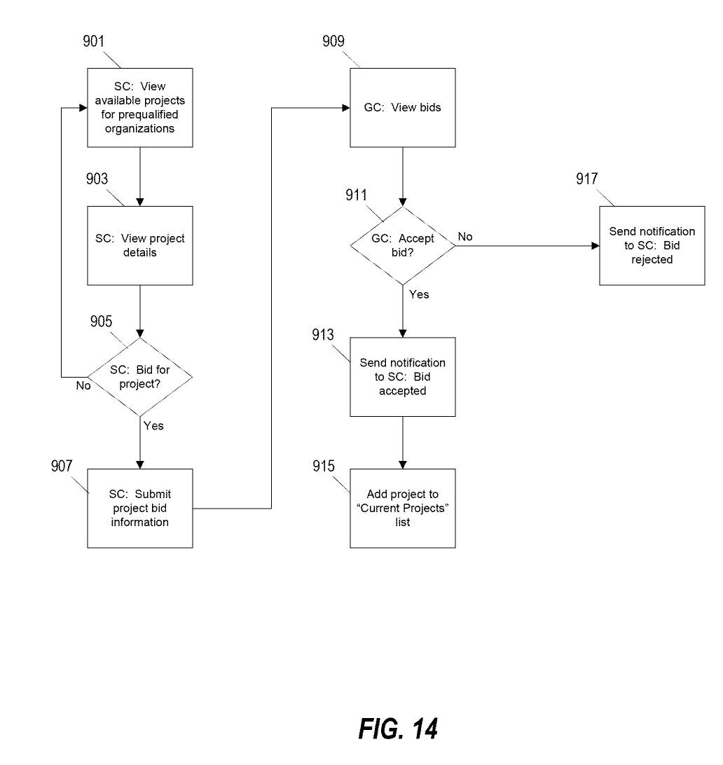

After the submitting organization (e.g., the subcontractor) has received prequalification approval from a reviewing organization (e.g., the general contractor), the submitting organization is allowed to submit bids for projects associated with the reviewing organization. FIG. 14 illustrates one such bid submission process. The subcontractor, now the bidding organization, views available projects from an organization for which it is prequalified (step 901). The subcontractor selects a project and views the project details (step 903) and decides whether to submit a bid for that project (step 905). If the subcontractor does not want to submit a bid, the subcontractor can return to browsing other available projects (step 901). Alternatively, the subcontractor can prepare a bid for the project and submit the bid to the general contractor or other reviewing organization (step 907). The general contractor receives a list of several bids and views the bid details (step 909). As described in detail below, the CPMS processes the received bids and prequalification preference information to present the submitted bids by suggested rank. The general contractor then selects a subcontractor based on the bid information and prequalification information. The selected subcontractor receives a notification that their bid has been accepted and that they have been awarded the project (step 913). The subcontractor is then added to the project and the project is then added to the subcontractor's “current projects” list (step 915). All other bidding organizations receive a notification informing them that they were not selected for the project (step 917).

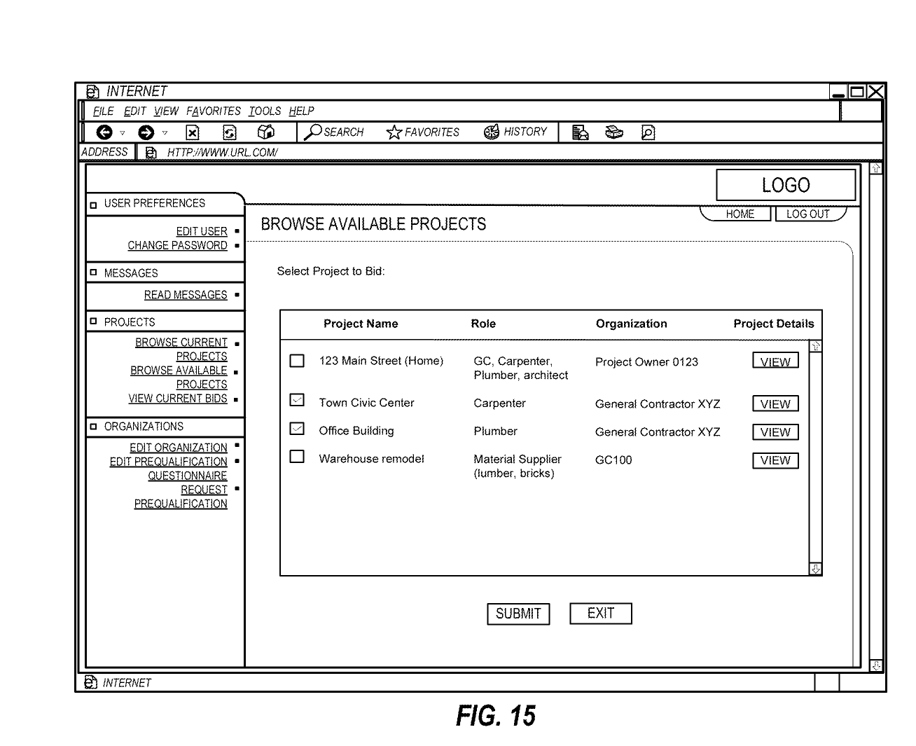

FIG. 15 illustrates an example of an interface by which a subcontractor selects projects for which to submit bids. The interface provides a list of projects sorted by project name. For each project, the interface also displays a list of roles for which bids are being accepted and identifies the organization that is receiving and reviewing the submitted bids. A bidding organization can view additional project details such as other associated organizations, building timeline, and project location by clicking the “view” button adjacent to the project listing. The bidding organization then selects one or more projects to bid on and clicks the “submit” button. The bidding organization is then prompted to submit bid information through an electronically fillable form and/or by uploading an electronic document.

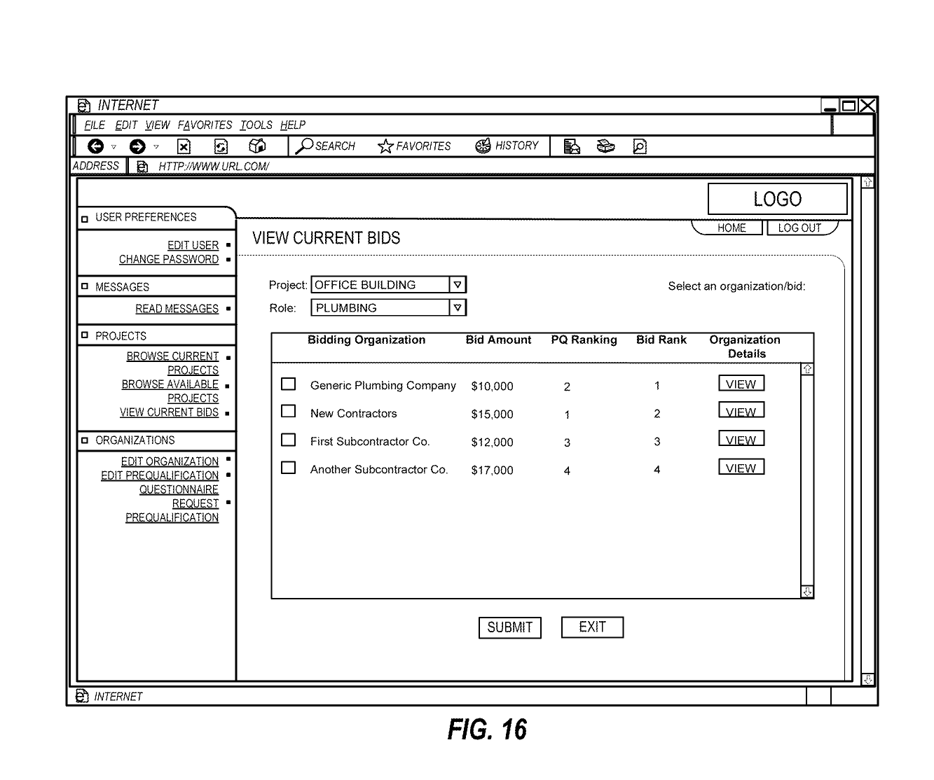

FIG. 16 illustrates an example of an interface by which a general contractor or other reviewing organization views submitted bids and selects an organization to be associated with the project. The interface provides a plurality of drop-down selection boxes that allow the reviewing organization to select the project and the role within the project. Based on these selections, the interface provides a list of all of the bids that have been submitted for the project. The list identifies the bidding organization and the total estimated dollar amount submitted by the organization. The CPMS also provides a “prequalification rank” and a “bid rank” for each bid submission.

As discussed above, the automated prequalification system evaluates the information submitted in the prequalification application and may assign a score to the submitting organization based on the preferences of the reviewing organization. When defining the minimum requirements for prequalification, the reviewing organization is also asked to provide a weighting system for different categories of information. For example, a general contractor may be primarily concerned with the subcontractor's percentage of previous projects completed on time and under budget. Another general contractor may be more concerned with any prior or pending litigation against a subcontractor. Based upon the reviewing organization's weighting preferences, the prequalification system assigns a score to each prequalified subcontractor. The CPMS assigns a “prequalification ranking” based on the bidding organization's prequalification score as compared to the other bidding organizations for a given project. The prequalification ranking may also be influenced by other factors such as, for example, the number of current projects associated with the bidding organization as compared to the bidding organization's number of employees.

Although each reviewing organization is able to create its own customized ratings framework by providing a weighting system for different categories of information, in some embodiments, the system uses the ratings of the individual categories of information to create a generalized ratings framework. The generalized ratings framework can provide an aggregated common rating score for organizations based on comparable data used in several prequalification applications. In some embodiments, the prequalification rating score can be displayed by a potential submitting organization as a marketing tool to attract new general contractors who might then request that the submitting organization initiate the prequalification process. As a result, a reviewing organization is able to determine whether to approve a submitting organization for prequalification using the reviewing organization's own customized ratings framework, but can also compare a potential submitting organization to other potential submitting organizations before initiating the prequalification process by viewing an aggregated generalized rating of the organization.

The CPMS also assigns a “bid rank” for each submitted bid. The bid rank is calculated based on the prequalification score and the information contained in the bid proposal including, for example, the projected completion date and the estimated cost of completion. As shown in FIG. 14, “Generic Plumbing Company” has a lower prequalification score than “New Contractors.” However, because the bid submitted by “Generic Plumbing Company” is substantially lower than the bid submitted by “New Contractors,” “Generic Plumbing Company” receives the highest bid rank.

Before selecting a subcontractor, the reviewing organization can view, download, and print the bid proposal from each bidding organization by selecting the “view” button adjacent to each bid listing.

Although the examples described above primarily discuss the interactions between a subcontractor and a general contractor, the invention can be used to facilitate interactions between other pairings of “submitting organizations” and “reviewing organizations.” Furthermore, the prequalification system can be integrated into a comprehensive project management system that maintains schedules, updates project budgets, and initiates payments between project participants. Alternatively, the prequalification system can be a standalone application that does not participate in the project management process. Lastly, although the examples described above include either manual approval (FIG. 3) or automated approval (FIG. 12), some embodiments of the invention include various combinations of automated and manual approvals. For example, some embodiments of the invention are able to automatically reject an application based on minimum criteria set by the reviewing organization, but require manual approval of the application before the submitting organization is prequalified. Various features and advantages of the invention are set forth in the accompanying claims.

1. A computer-based method of managing bid proposals from prequalified organizations, the method comprising:
establishing electronic communication between a server and a first device through a computer network;
electronically receiving business information for a first organization from the first device through the computer network, wherein the business information includes a plurality of data items relating to the first organization;
establishing electronic communication between the server and a second device through the computer network;
electronically receiving minimum requirements for a second organization from the second device through the computer network, wherein the minimum requirements include a plurality of data items defining requirements for candidates for prequalification;
executing a set of computer instructions stored on a memory associated with the server, wherein the computer instructions compare one or more data items from the business information to one or more data items from the minimum requirements;
when the business information meets the minimum requirements, electronically sending a prequalification accepted notification to the first organization and the second organization, displaying to the first organization a bid request received from the second organization, and electronically receiving a bid proposal from the first organization; and
when the business information does not meet the minimum requirements, electronically sending a prequalification rejected notification to the first organization and the second organization, and disallowing the first organization from sending a bid proposal in response to a bid request received from the second organization.

2. The method according to claim 1, wherein the minimum requirements include a minimum prequalification score, the method further comprising generating a prequalification score for the first organization based on the received business information, and wherein the computer instructions compare the prequalification score to the minimum prequalification score.

3. The method according to claim 2, further comprising
calculating a bid score for the first organization based on the received bid proposal and the prequalification score;
comparing the bid score for the first organization to one or more bid scores from additional organizations; and
sending a bid notification to the second organization identifying the organization with a highest bid score.

4. The method according to claim 3, further comprising
electronically receiving a response to the bid notification from the second organization either accepting or rejecting the bid from the organization with the highest bid score;
when the response accepts the bid from the organization with the highest bid score, sending a bid accepted notification to the organization with the highest bid score; and
when the response rejects the bid from the organization with the highest bid score, sending a second bid notification to the second organization identifying the organization with a next highest bid score.

5. The method according to claim 1, wherein the minimum requirements include a defined intermediate range for one or more of the plurality of data items of the business information, the method further comprising
determining if the one or more of the plurality of data items falls within the defined intermediate range; and
when the one or more of the plurality of data items falls within the defined intermediate range, sending a manual approval request to the second organization, and receiving a response to the manual approval request from the second organization either approving or rejecting the first organization,
wherein the business information meets the minimum requirements when the one or more of the plurality of data items exceeds an upper bound of the defined intermediate range or when the response to the manual approval request approves the first organization, and
wherein the business information does not meet the minimum requirements when the one or more of the plurality of data items does not exceed a lower bound of the defined intermediate range or when the response to the manual approval request rejects the first organization.

6. The method of claim 1, further comprising
receiving a prequalification request from the second organization identifying the first organization as a candidate for prequalification;
sending a notification to the first organization requesting an approval of the prequalification request; and
receiving the approval from the first organization,
wherein the computer instructions compare the business information to the minimum requirements after the approval is received from the first organization.

7. The method of claim 1, further comprising receiving a prequalification request from the second organization identifying the first organization as a candidate for prequalification, wherein the computer instructions compare the business information to the minimum requirements after the prequalification request is received.

8. The method of claim 1, further comprising
receiving a prequalification request from the first organization requesting prequalification for bid requests submitted by the second organization;
sending a notification to the second organization requesting an approval of the prequalification request; and
receiving the approval from the second organization,
wherein the computer instructions compare the business information to the minimum requirements after the approval is received from the second organization.

9. The method of claim 1, further comprising receiving a prequalification request from the first organization requesting prequalification for bid requests submitted by the second organization, wherein the computer instructions compare the business information to the minimum requirements after the prequalification request is received.

10. The method of claim 1, wherein the minimum requirements includes a list of data items that must be included in the business information before the first organization can be prequalified, the method further comprising
determining whether the business information includes each of the data items identified by the minimum requirements; and
when the business information does not include each of the data items, sending an additional information request to the first organization identifying additional information that must be received by the server, and receiving the additional information from the first organization,
wherein the computer instructions compare the business information to the minimum requirements only when the business information includes each of the data items identified by the minimum requirements.

11. The method of claim 1, further comprising:
displaying to the first organization, when the business information meets the minimum requirements, a list of a plurality of bid requests submitted by the second organization; and
receiving from the first organization, when the business information meets the minimum requirements, a bid proposal for one or more of the plurality of bid requests.

12. The method of claim 1, wherein the first device is a personal computer connected to the network.

13. The method of claim 1, wherein the server includes an Internet connection and wherein the network includes the Internet.

14. The method of claim 1, wherein the plurality of data items includes one or more of insurance information, a list of references, a list of litigation involving the first organization, and bonding information.

15. The method of claim 1, wherein notifications are sent to the first organization through the first device.

16. The method of claim 1, wherein notifications are sent to the first organization through at least one of a telephone, an email server, and a fax machine.

17. The method of claim 1, wherein the first organization is a subcontractor and the second organization is a general contractor.
